(19) United States
(12) Patent Application Publication
(10) Pub. No.: US 2019/0306091 A1
(43) Pub. Date: Oct. 3, 2019

(54) APPLICATION ACCESS CONTROL FOR TEXT-BASED MESSAGES

(71) Applicant: CA, Inc., Islandia, NY (US)

(72) Inventors: Mohammed Mujeeb Kaladgi, Bangalore (IN); Ruqiya Nikhat Kaladgi, Bangalore (IN); Mahendra Nimishakavi, Bengaluru (IN)

(73) Assignee: CA, Inc., Islandia, NY (US)

(21) Appl. No.: 15/939,184

(22) Filed: Mar. 28, 2018

(51) Int. Cl. H04L 12/58; H04L 29/06; H04W 4/14

(52) U.S. Cl. CPC H04L 51/046; H04W 4/14; H04L 51/18; H04L 63/101

(57) ABSTRACT

According to one aspect of the present disclosure, a text-based message is received on a device. The text-based message includes an access control indicator in a body of the text-based message. The text-based message is parsed to locate the access control indicator, and it is determined whether the access control indicator is associated with a particular entry in an access control table. The access control table includes associations between one or more access control indicators and one or more applications on the device. It is determined that the text-based message is associated with a particular one of the applications on the device based on determining that the access control indicator is associated with the particular entry, and access to the text-based message by the particular application on the device is allowed based on determining, from the access control indicator, that the text-based message is associated with the particular application.

### BACKGROUND

The present disclosure relates in general to information security, and more specifically, to controlling access by applications to text-based messages received at a device.

Applications on a device (e.g., mobile phones) may have access to read text-based messages (e.g., SMS messages). However, a user of the device might not be aware of what the application does with those messages. Sometimes, sensitive information may be included in the text-based messages (e.g., one-time passwords for accounts, financial transaction data, health related information, or other personal information). Currently, there is no known way to limit access to certain text-based messages by specific applications.

### BRIEF SUMMARY

According to one aspect of the present disclosure, a text-based message may be received on a device. The text-based message may include an access control indicator in a body of the text-based message. The text-based message may be parsed to locate the access control indicator, and it may be determined whether the access control indicator is associated with a particular entry in an access control table that includes associations between one or more access control indicators and one or more applications on the device. It may be determined that the text-based message is associated with a particular one of the applications on the device based on determining that the access control indicator is associated with the particular entry, and the particular application may be allowed access to the text-based message based on determining, from the access control indicator, that the text-based message is associated with the particular application.

### BRIEF DESCRIPTION OF THE DRAWINGS

FIG. 1A illustrates an example environment for controlling access to text-based messages by applications on a user device.

FIG. 1B illustrates an example text-based message that includes an access control indicator.

FIG. 1C illustrates a simplified block diagram of the example user device of FIG. 1A.

FIG. 2 illustrates an example signaling sequence for associating an application with an access control access control indicator.

FIG. 3 illustrates an example signaling sequence for initializing a device after an application is installed on the device.

FIG. 4 illustrates an example signaling sequence for controlling access to a text-based message based on an access control indicator.

FIG. 5 illustrates another example signaling sequence for controlling access to a text-based message based on an access control indicator.

FIG. 6 illustrates another example signaling sequence for controlling access to a text-based message based on an access control indicator.

FIG. 7 illustrates another example signaling sequence for controlling access to a text-based message based on an access control indicator.

FIG. 8 is a flowchart illustrating an example process for controlling access to a text-based message based on access control indicators.

Like reference numbers and designations in the various drawings indicate like elements.

### DETAILED DESCRIPTION

As will be appreciated by one skilled in the art, aspects of the present disclosure may be illustrated and described herein in any of a number of patentable classes or contexts, including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or as a combination of software and hardware implementations, all of which may generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), or in a cloud computing environment, or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices, to produce a computer implemented process such that the instructions which execute on the computer or other programmable apparatus provide processes for implementing the functions/acts specified in the flowchart and/or block diagram block or blocks.

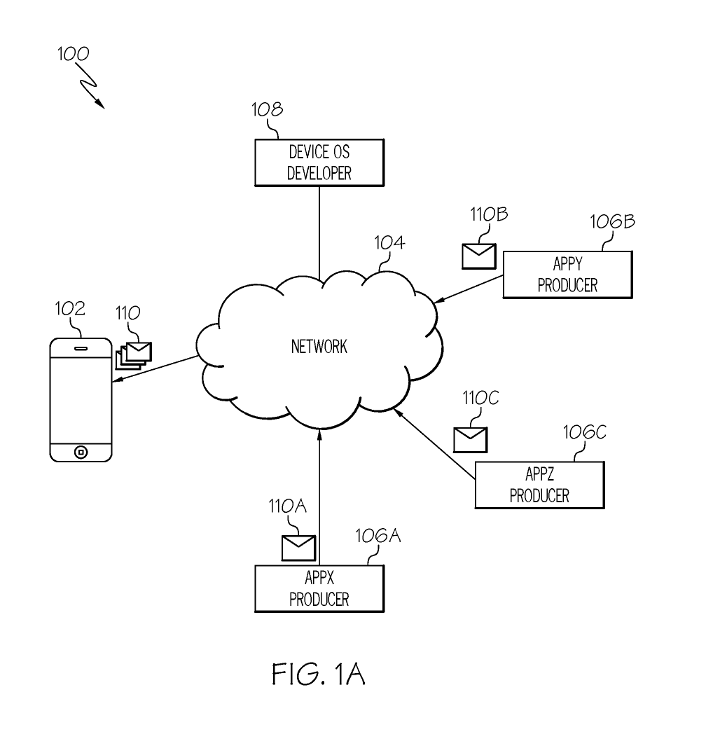

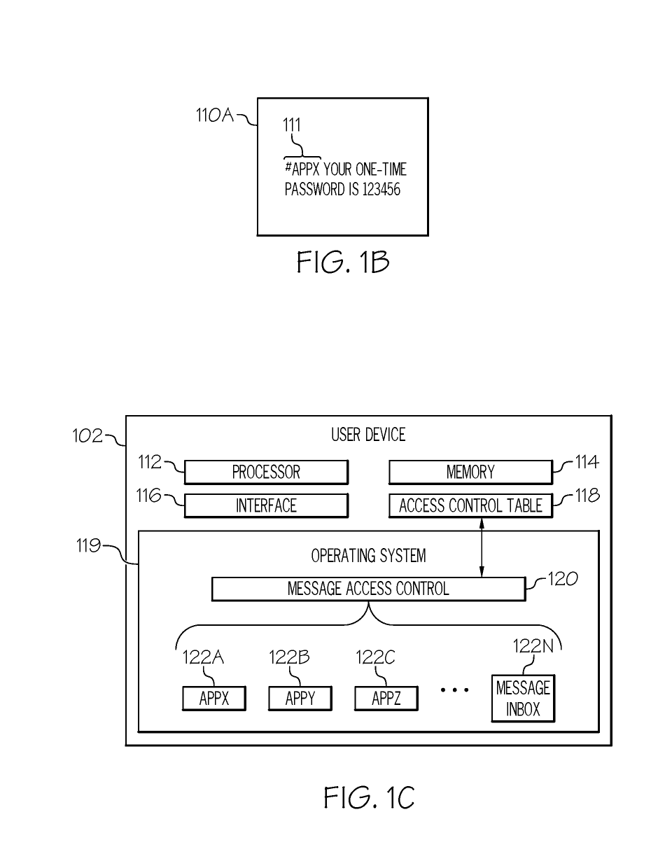

FIG. 1A illustrates an example environment 100 for controlling access to text-based messages 110 by applications on a user device 102. In certain aspects of the present disclosure, application access to such messages may be controlled on a message-specific basis, rather than a global basis. For instance, in current techniques, applications may be granted either full, global access to text-based messages (i.e., access to all messages) or no access at all. This may cause privacy issues with respect to certain text-based messages that contain sensitive information, such as health information, banking information, personal information, password information, or other types of sensitive information. Thus, in certain aspects, applications of a user device may be granted access only to specific messages, rather than all text-based messages received by the user device.

In the example shown, the application producers 106 each send a text-based message 110 to the user device 102 over the network 104. The user device 102 in the example shown is a personal computing device, such as a smartphone. In some instances, the user device 102 may be implemented as described below with respect to FIG. 1C. The network 104 in the example shown may include one or more networks of different types, including, for example, local area networks, wide area networks, public networks, the Internet, cellular networks, Wi-Fi networks, short-range networks (e.g., Bluetooth or ZigBee), and/or any other wired or wireless communication medium. The application producers 106 in the example shown may be one or more computing devices that are associated with the developer of the application. For example, each application producer 106 may include a text-based messaging service endpoint, a server associated with application updates, or another type of server device. The OS developer 108 in the example shown may be one or more computing devices that are associated with the developer of operating system software for the user device 102. The text-based messages 110 may be any suitable type of text-based message, and may include one or more of a short message service (SMS) message, a multimedia message service (MMS) message, or another type of text-based message. In some instances, the text-based messages are formatted similar to the text-based message 110A of FIG. 1B.

The application producers 106 may each send different kinds of data to the user device 102 in the text-based messages 110. For example, the application producer 106A may provide banking transactions or other financial information to the user device 102 in the text-based message 110A, the application provider 106B may provide health or other personal information to the user device 102 in the text-based message 110B, and the application provider 106C may provide one-time passwords or other credential information to the user device 102 in the text-based message 110C. A user of the user device 102 may wish to prevent the applications of the user device 102 from accessing each of these types of messages.

Thus, in certain aspects, each of the application producers 106 may register a unique access control indicator (similar to the access control indicator 111 of FIG. 1B) for their text-based message sending service endpoint (e.g., a server configured to send text-based messages, such as SMS messages, to user devices on behalf of the application producer), and may include the access control indicator in their text-based messages. The user device 102 may parse the received text-based messages 110 (e.g., parse the body of the message) to locate an access control indicator therein, and may provide access to the text-based messages 110 based on which applications are associated with the access control indicator in an access control table (e.g., the access control table 118 of FIG. 1C) stored on the user device 102.

For instance, in the example shown, each of the application producers 106 may register a unique access control indicator with the operating system (OS) developer 108. The OS developer 108 may provide operating system software for user devices, such as user device 102, and may provide the registered access control indicators to the user devices (e.g., through operating system software updates). As an example, the application producer 106A may register the unique access control indicator “#AppX” with the OS developer 108 and register its SMS endpoint (e.g., a server device) with the access control indicator. Likewise, the application producer 106B may register the unique access control indicator “#AppY” with the OS developer 108, and the application producer 106C may register the unique access control indicator “#AppZ” with the OS developer 108. In some cases, the application producer 106 can publish a schema to the OS developer 108. The OS developer 108 may store the application/access control indicator associations in a “master” access control table (e.g., in a database or on one of its servers).

The OS developer 108 may provide one or more of the application/access control indicator associations in the master access control table to the user device 102. For example, the OS developer 108 may send one or more messages to the user device 102 that indicate the end point/access control indicator associations, and the user device 102 may store the associations in an access control table (e.g., the access control table 118 of FIG. 1C). The user device 102 may then use the application/access control indicator associations store in its access control table to determine access permissions for received text-based messages. For example, the user device 102 may allow text-based messages originating from a registered message endpoint of the application producer 106A to be accessed by an application on the user device 102 that is associated with the application producer 106A. In some instances, the user device 102 may provide an application access to a text-based message only when the text-based message contains registered access control indicator associated with the application, and the text-based message originated from a registered endpoint for the access control indicator.

In some cases, applications installed on the user device 102 can ask for permissions to read text-based messages received at the device (e.g., upon installation), and users of the device 102 can choose which unique access control indicators the applications may have access to. For example, a user may provide a money wallet application access to text-based messages related to one particular bank or financial institution that the user chooses (e.g., by selecting access control indicators), but not the rest of incoming text-based messages. In some instances, a user interface of the user device 102 can indicate the application/access control indicator associations that are stored in its access control table. In some cases, a newly installed application can register itself with the OS of the user device 102, and the OS of the user device can query the OS developer 108 to determine whether a unique access control indicator is associated with the newly installed application. If so, the application/access control indicator association may be provided to the user device 102. If not, the application may be allowed to register a new access control indicator with the OS developer 108.

FIG. 1B illustrates an example text-based message 110A that includes an access control indicator 111. In the example shown, the body of the text-based message 110A begins with the access control indicator 111 (“#AppX”), which is followed by the remainder of the message (“your one-time password is 123456”). The access control indicator 111 may be in another location of the text-based message 110A. For example, the indicator may be in the middle of the body of the message (e.g., “your one-time password for #AppX is 123456”), or at the end of the body of the message (e.g., “your one-time password is 123456 #AppX”). In the example shown, the access control indicator 111 begins with a symbol (e.g., a delimiter) and is followed by a set of alphanumeric characters. The access control indicator 111 may be formatted in another manner. For example, the indicator 111 may begin with the set of alphanumeric characters and be followed by a symbol. A user device that receives the text-based message 110A (e.g., user device 102 of FIGS. 1A, 1C) may control access to the text-based message 110A (e.g., provide access to the text-based message, such as read permissions) based on detection of the access control indicator 111.

FIG. 1C illustrates a simplified block diagram of the example user device of FIG. 1A. In the example shown, the user device 102 includes a processor 112, memory 114, and an interface 116. The example processor 112 executes instructions, for example, to control application access to text-based messages based on access control indicators in the text-based messages. The instructions can include programs, codes, scripts, or other types of data stored in memory. Additionally, or alternatively, the instructions can be encoded as pre-programmed or re-programmable logic circuits, logic gates, or other types of hardware or firmware components. The processor 112 may be or include a general-purpose microprocessor, as a specialized co-processor or another type of data processing apparatus. In some cases, the processor 112 may be configured to execute or interpret software, scripts, programs, functions, executables, or other instructions stored in the memory 114. In some instances, the processor 112 includes multiple processors or data processing apparatuses.

The example memory 114 includes one or more computer-readable media. For example, the memory 114 may include a volatile memory device, a non-volatile memory device, or a combination thereof. The memory 114 can include one or more read-only memory devices, random-access memory devices, buffer memory devices, or a combination of these and other types of memory devices. The memory 114 may store instructions (e.g., programs, codes, scripts, or other types of executable instructions) that are executable by the processor 112.

The example interface 116 provides communication between the user device 102 and one or more other devices. For example, the interface 116 may include a network interface (e.g., a wireless interface or a wired interface) that allows communication between the user device 102 and the other devices shown in FIG. 1A over the network 104. The interface 116 may include another type of interface, such as an interface for connecting other hardware components to the user device 102.

The example user device 102 also includes an access control table 116 that stores application/access control indicator associations as described above. The access control table 116 may include associations between the applications 122 installed the user device 102 and one or more access control indicators. In some cases, the access control table indicates only one application association for an access control indicator. That is, each access control indicator may be associated, in some cases, with exactly one application on the user device 102. The access control table 116 may also include associations between access control indicators and one or more messaging services endpoints. The associations in the access control table 116 may be based on associations in a master access control, which may be managed by a central entity (e.g., the OS developer 108 of FIG. 1A). The access control table 116 may be stored in the memory 114, in some instances.

The example user device 102 runs (via the processor 112) an operating system 119 that manages execution of the message access control engine 120 and the applications 122. The message access control engine 120 includes instructions, executable by the processor 112, for providing access to text-based messages by the applications 122 based on access control indicators in the text-based messages. For example, the message access control engine 120 may include instructions to parse a newly received (e.g., via the interface 116) text-based message to locate an access control indicator (if any), and access application/access control indicator associations stored in the access control table 118 to determine which (if any) application 122 on the user device 102 should have access to the text-based message. The message access control engine 120 may be implemented in software, firmware, hardware, or a combination thereof.

The applications 122 include code, scripts, or other instructions that run on the processor 112 of the user device 102 to perform one or more functions. In the example shown, the application 122A is associated with the application provider 106A of FIG. 1A, the application 122B is associated with the application provider 106B of FIG. 1A, and the application 122C is associated with the application provider 106C of FIG. 1A. The application 122N is an application that provides an inbox view of text-based messages received by the user device 102. In some instances, the application 122N has access to all text-based messages received by the user device 102. In other instances, the application 122N has access only to text-based messages received by the user device 102 that (1) are not associated with a particular application 122 or (2) do not have an access control indicator. In some cases, one or more of the applications 122 includes an SMS listener or similar code that monitors incoming SMS messages (e.g., to perform one or more operations based on certain received messages), and the SMS listener is provided with messages to which the application is to have access. The user device 102 may include applications other than the applications 122 shown in FIG. 1C.

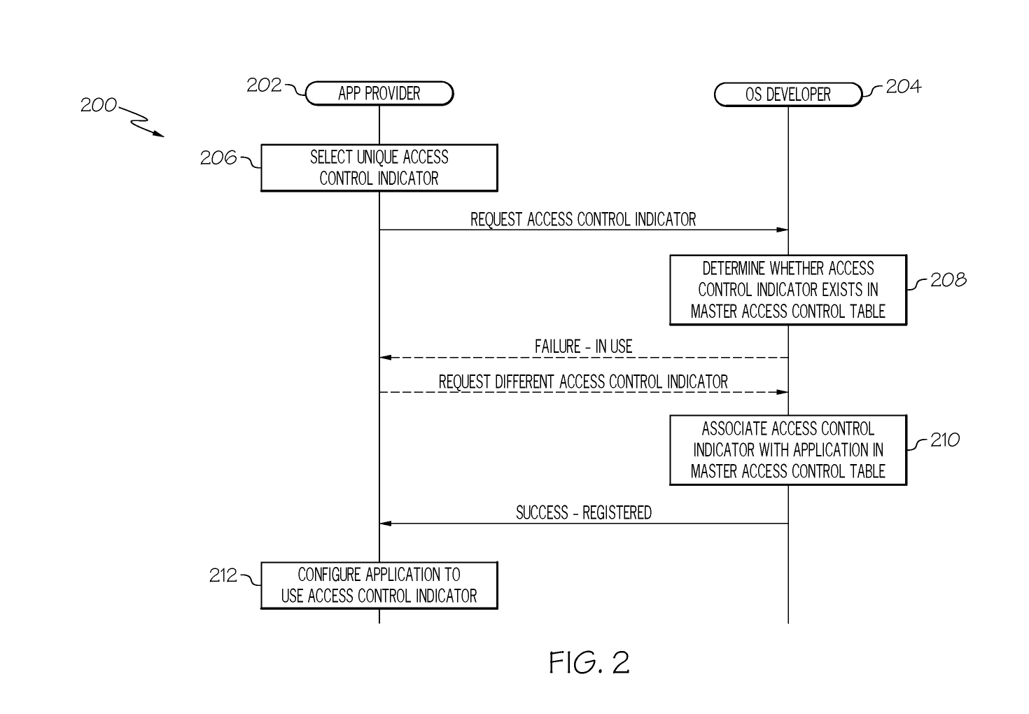

FIG. 2 illustrates an example signaling sequence 200 for associating an application with an access control access control indicator. The example sequence 200 involves an application provider 202 (e.g., one of the application providers 106 of FIG. 1A) and an OS developer 204 (e.g., the OS developer 108 of FIG. 1A). Operations of the sequence 200 may be performed by one or more computing devices associated with application provider 202 or the OS developer 204. The sequence 200 may include additional or fewer operations than those shown in FIG. 2.

In the example shown, the application provider 202 first selects a unique access control indicator for use with its application at 206. The application provider 202 sends a request to the OS developer 204 to register the selected unique access control indicator with an application of the application provider 202. The OS developer 204 determines at 208 whether the access control indicator exists already (e.g., is associated with another application) in a master access control table. If the access control indicator does exist in the access control table, the OS developer 204 returns a failure and the application provider 202 request a different access control indicator instead. If the access control indicator does not exist in the access control table, the OS developer associates the access control indicator with the application of the application provider 202 in the master access control table at 210, and sends an indication of registration success to the application provider 202. The application provider 202 then configures its application to include the registered access control indicator in text-based messages (e.g., SMS messages) sent by its messaging service endpoint.

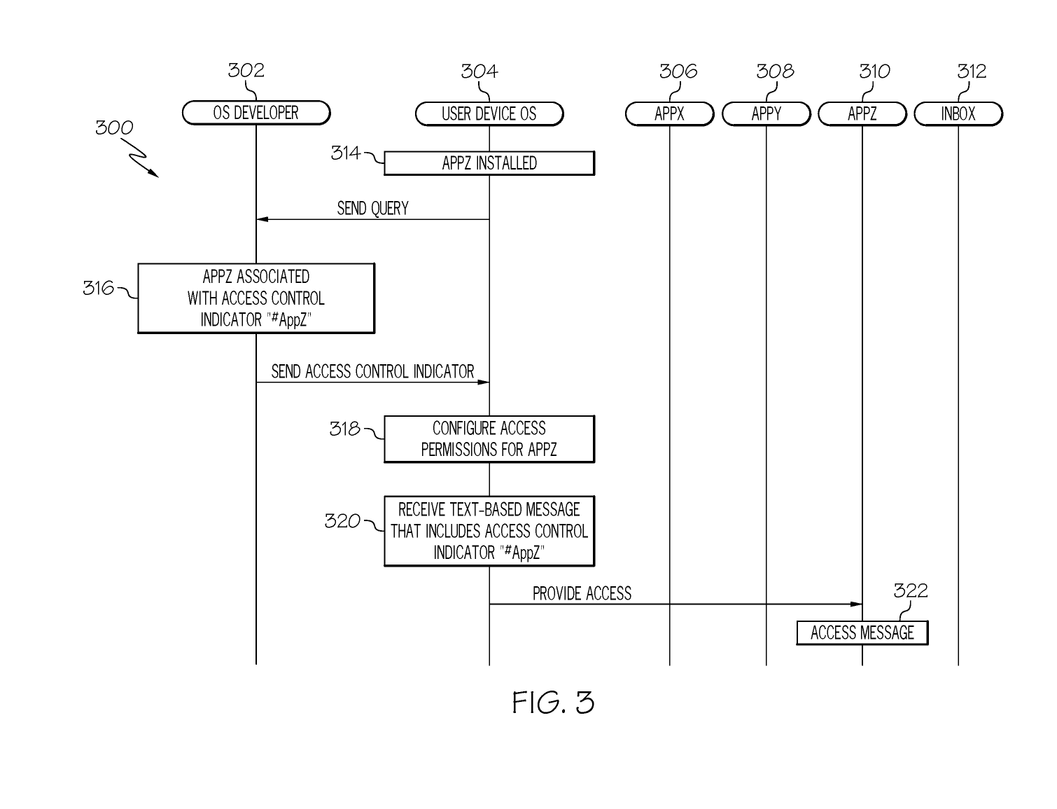

FIG. 3 illustrates an example signaling sequence 300 for initializing a device after an application is installed on the device. The example sequence 300 involves an OS developer 302 (e.g., the OS developer 108 of FIG. 1A), a user device OS 304 (e.g., the operating system 119 of FIG. 1C), and applications AppX 306, AppY 308, AppZ 310, and Inbox 312 (e.g., applications AppX 122A, AppY 122B, AppZ 122C, and Message Inbox 122N of FIG. 1C). Operations of the sequence 300 may be performed by one or more computing devices associated with the OS developer 302 and the user device OS 304 (e.g., the processor 112 of FIG. 1C). The sequence 300 may include additional or fewer operations than those shown in FIG. 3.

In the example shown, AppZ 310 is installed on the user device at 314. In response, the user device OS 304 sends a query to the OS developer 302 to determine whether the OS developer 302 has or is aware of an association between AppZ 310 and a particular access control indicator (e.g., in a master access control table). The OS developer 302 determines at 316 that the newly installed AppZ 310 is associated with the access control indicator “#AppZ”, and provides the associated access control indicator to the user device. The user device OS 304 then configures access permissions for AppZ 310 at 318 based on the access control indicator received from the OS developer 302. In some cases, the user device 304 may configure access permissions by storing the association of AppZ 310 and the access control indicator “#AppZ” in a local access control table (e.g., the access control table 118 of FIG. 1C). The access control table of the user device may include other application/access control indicator associations as well.

Sometime later, at 320, the user device OS 304 receives a text-based message that includes the access control indicator “#AppZ” (e.g., at the beginning of the text-based message, similar to the text-based message 110A of FIG. 1B). In some cases, the user device OS 304 parses the received text-based message to locate the access control indicator, and performs a lookup in its access control table to determine whether the access control indicator is associated with an installed application. In the example shown, the access control indicator “#AppZ” is associated with AppZ 310, so the user device OS 304 provides AppZ 310 access to the text-based message received at 320. In the example shown, the other applications are not provided access to the text-based message.

AppZ 310 then accesses the message at 322. Accessing the message may include reading contents the message to collect information in the message or about the message, determining whether to perform one or more functions based on information in the message, displaying the message inside the application, or performing another operation.

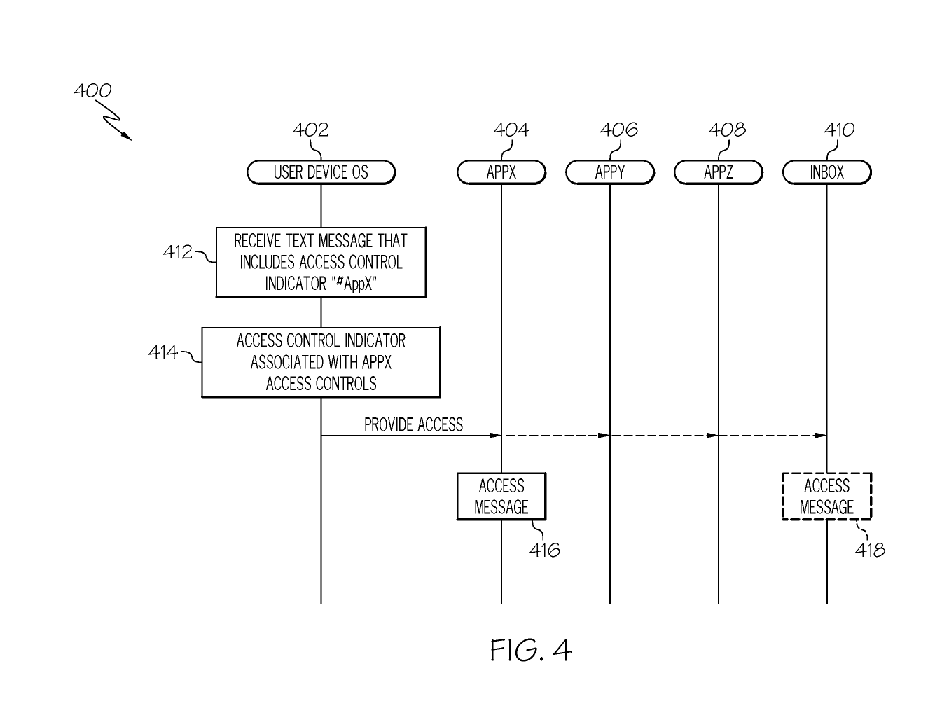

FIG. 4 illustrates an example signaling sequence 400 for controlling access to a text-based message based on an access control indicator. The example sequence 400 involves a user device OS 402 (e.g., the operating system 119 of FIG. 1C), and applications AppX 404, AppY 406, AppZ 408, and Inbox 410 (e.g., applications AppX 122A, AppY 122B, AppZ 122C, and Message Inbox 122N of FIG. 1C). Operations of the sequence 400 may be performed by one or more computing devices associated with the user device OS 402 (e.g., the processor 112 of FIG. 1C). The sequence 400 may include additional or fewer operations than those shown in FIG. 4.

In the example shown, the user device OS 402 receives a text-based message at 412 that includes the access control indicator “#AppX” (e.g., at the beginning of the text-based message, similar to the text-based message 110A of FIG. 1B). In some cases, the user device OS 402 parses the received text-based message to locate the access control indicator, and performs a lookup in its access control table to determine whether the access control indicator is associated with an installed application. In the example shown, the access control indicator “#AppX” is associated with AppX 404, so the user device OS 402 provides AppX 404 access to the text-based message received at 412. In some cases, a general messaging inbox application 410 may also be provided access to the text-based message. In the example shown, AppY 406 and AppZ 408 are not provided access to the text-based message.

AppX 404 then accesses the message at 416. Accessing the message may include reading contents the message to collect information in the message or about the message, determining whether to perform one or more functions based on information in the message, displaying the message inside the application, or performing another operation. In some cases, the general messaging inbox application 410 accesses the message at 418.

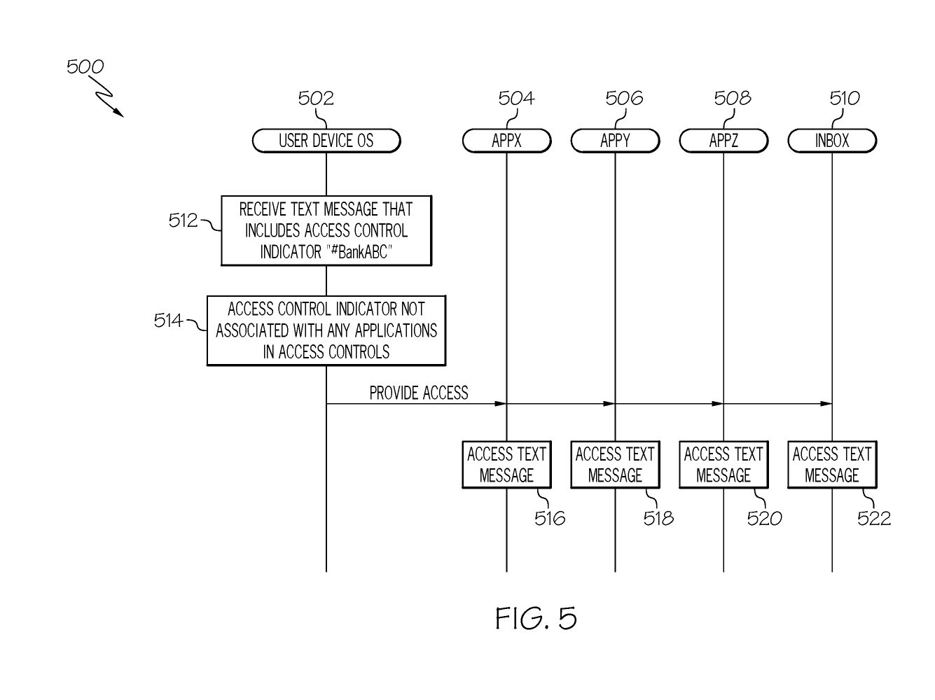

FIG. 5 illustrates another example signaling sequence 500 for controlling access to a text-based message based on an access control indicator. The example sequence 500 involves a user device OS 502 (e.g., the operating system 119 of FIG. 1C), and applications AppX 504, AppY 506, AppZ 508, and Inbox 510 (e.g., applications AppX 122A, AppY 122B, AppZ 122C, and Message Inbox 122N of FIG. 1C). Operations of the sequence 500 may be performed by one or more computing devices associated with the user device OS 502 (e.g., the processor 112 of FIG. 1C). The sequence 500 may include additional or fewer operations than those shown in FIG. 5.

In the example shown, the user device OS 502 receives a text-based message at 512 that includes an access control indicator “#BankABC” (e.g., at the beginning of the text-based message). In some cases, the user device OS 502 parses the received text-based message to locate the access control indicator, and performs a lookup in its access control table to determine whether the access control indicator is associated with an installed application. In the example shown, the access control indicator “#BankABC” is not associated with any installed applications, so all of the applications 504, 506, 508, 510 are provided access to the message. Another rule may be provided for instances where there is an access control indicator, but no known application associated with the access control indicator.

AppX 504, AppY 506, AppZ 508, and the general messaging inbox 510 each access the message at 516, 518, 520, 522, respectively. Accessing the message may include reading contents the message to collect information in the message or about the message, determining whether to perform one or more functions based on information in the message, displaying the message inside the application, or performing another operation.

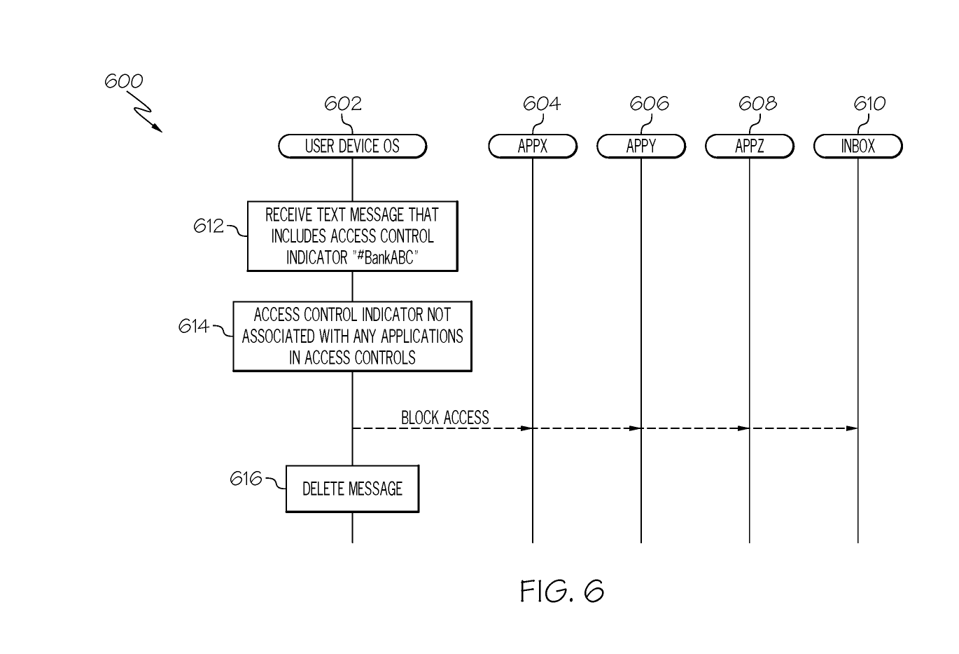

FIG. 6 illustrates another example signaling sequence 600 for controlling access to a text-based message based on an access control indicator. The example sequence 600 involves a user device OS 602 (e.g., the operating system 119 of FIG. 1C), and applications AppX 604, AppY 606, AppZ 608, and Inbox 610 (e.g., applications AppX 122A, AppY 122B, AppZ 122C, and Message Inbox 122N of FIG. 1C). Operations of the sequence 600 may be performed by one or more computing devices associated with the user device OS 602 (e.g., the processor 112 of FIG. 1C). The sequence 600 may include additional or fewer operations than those shown in FIG. 6.

In the example shown, the user device OS 602 receives a text-based message at 612 that includes an access control indicator “#BankABC” (e.g., at the beginning of the text-based message). In some cases, the user device OS 602 parses the received text-based message to locate the access control indicator, and performs a lookup in its access control table to determine whether the access control indicator is associated with an installed application. In the example shown, the access control indicator “#BankABC” is not associated with any installed applications, so access to the message is not provided to any of the applications 604, 606, 608, 610 and the message is deleted by the user device OS 602 at 616. Another rule may be provided for instances where there is an access control indicator, but no known application associated with the access control indicator.

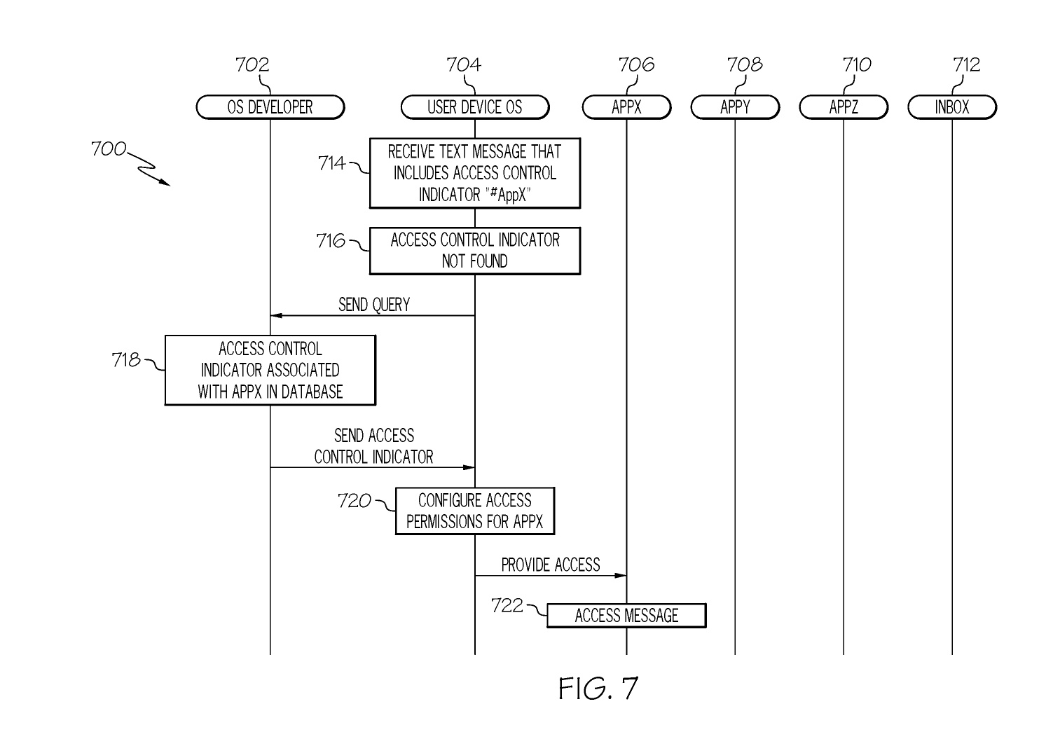

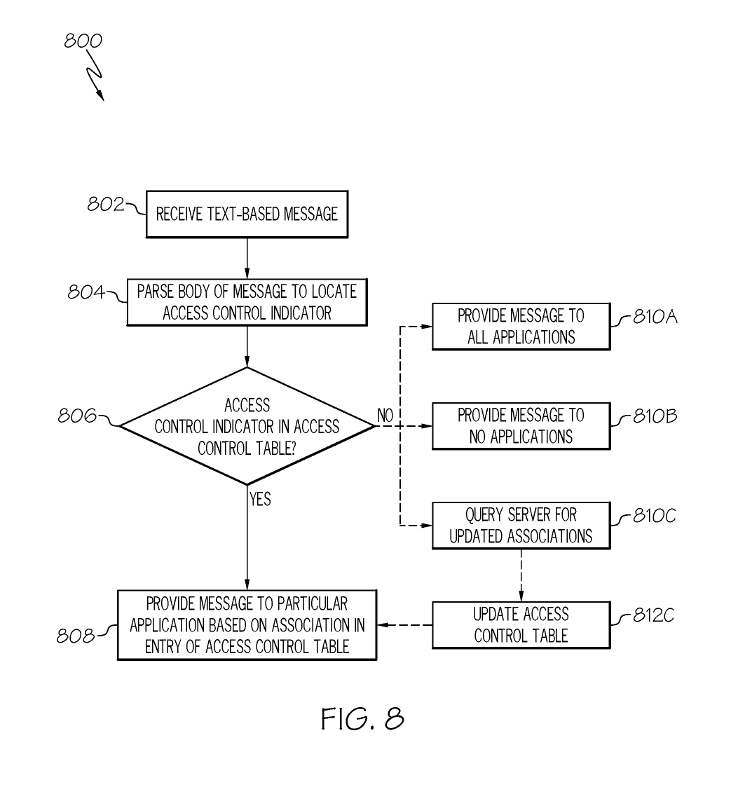

FIG. 7 illustrates another example signaling sequence 700 for controlling access to a text-based message based on an access control indicator. The example sequence 700 involves an OS developer 702 (e.g., the OS developer 108 of FIG. 1A), a user device OS 704 (e.g., the operating system 119 of FIG. 1C), and applications AppX 706, AppY 708, AppZ 710, and Inbox 712 (e.g., applications AppX 122A, AppY 122B, AppZ 122C, and Message Inbox 122N of FIG. 1C). Operations of the sequence 700 may be performed by one or more computing devices associated with the OS developer 702 and the user device OS 704 (e.g., the processor 112 of FIG. 1C). The sequence 700 may include additional or fewer operations than those shown in FIG. 7.

In the example shown, the user device OS 704 receives a text-based message at 712 that includes an access control indicator “#AppX” (e.g., at the beginning of the text-based message). In some cases, the user device OS 704 parses the received text-based message to locate the access control indicator, and performs a lookup in its access control table to determine whether the access control indicator is associated with an installed application. The user device OS 704 determines at 716 that the access control indicator is not found in its access control table, and accordingly sends a query to the OS developer 702 to determine whether the OS developer 702 has or is aware of an association with the access control indicator (e.g., in a master access control table).

The OS developer 702 determines at 718 that the application AppX 706 is associated with the access control indicator “#AppX” in the text-based message received at 714, and provides the associated access control indicator to the user device OS 704. The user device OS 704 then configures access permissions for AppX 706 at 720 based on the access control indicator received from the OS developer 702. In some cases, the user device OS 704 may configure access permissions by storing the association of AppX 706 and the access control indicator “#AppX” in its access control table (e.g., the access control table 118 of FIG. 1C). The user device OS 704 then provides AppX 706 access to the text-based message. In the example shown, access is provided to AppX 706 without providing access to AppY 708, AppZ 710, and Inbox 712. AppX 706 then accesses the message at 722. Accessing the message may include reading contents the message to collect information in the message or about the message, determining whether to perform one or more functions based on information in the message, displaying the message inside the application, or performing another operation.

FIG. 8 is a flowchart illustrating an example process 800 for controlling access to a text-based message based on access control indicators. Operations in the example process 800 may be performed by components of a computing device (e.g., the mobile device 102 of FIG. 1) with one or more applications installed thereon. The example process 800 may include additional or different operations, and the operations may be performed in the order shown or in another order. In some cases, one or more of the operations shown in FIG. 8 are implemented as processes that include multiple operations, sub-processes, or other types of routines. In some cases, operations can be combined, performed in another order, performed in parallel, iterated, or otherwise repeated or performed another manner.

At 802, a text-based message is received. The text-based message may be formatted in any suitable manner, and may be, for example, an SMS message, an MMS message, or a similar type of text-based message. The text-based message may be received by a user device (e.g., the user device 102 of FIGS. 1A, 1C) from a messaging service endpoint associated with an application (e.g., an endpoint of one of the application providers 106 of FIG. 1A). In some cases, the text-based message is formatted similar to the text-based message 110A of FIG. 1B.

At 804, the body of the text-based message is parsed to locate one or more access control indicators. The access control indicator may be formatted in any suitable manner. For example, in some cases, the access control indicator includes a symbol (e.g., the symbol “#” in the example shown in FIG. 1B) followed by a set of alphanumeric characters (e.g., the characters “AppX” in the example shown in FIG. 1B). Parsing the message may include parsing the message to locate the symbol, and then reading the characters that follow the symbol. The access control indicator may be formatted in another manner, and parsing the message may include other operations. The access control table may include associations between one or more access control indicators and one or more applications on the user device that received the text-based message. For instance, referring to the example shown in FIGS. 1A-1B, the access control table may include an association between the access control indicator “#AppX” and the application AppX associated with the application provider 106A. The associations in the access control table may indicate which application or applications should have access to a text-based message that includes the access control indicator. In some cases, the access control table also includes associations between one or more applications and one or more applications providers (e.g., with messaging service endpoints of the application providers).

At 806, it is determined whether the access control indicator is associated with an entry in an access control table. As described above, the entries in the access control table may indicate which application or applications should be granted access to a text-based message that includes a particular access control indicator. For instance, when a text-based message that includes the access control indicator “#AppX” is received, the entry in the access control table indicates that the application AppX should be provided access to the text-based message. In cases where the access control table also includes associations between applications and application provider endpoints, it may also be determined whether the text-based message was received from an endpoint associated with an application provider endpoint associated with the particular application. For example, when a text-based message that includes the access control indicator “#AppX” is received, it may be also determined whether the text-based message was received from a particular SMS Sender ID associated with the application provider of AppX.

If it is determined at 806 that the access control indicator is associated with an entry in the access control table, access to the text-based message received at 802 is provided to one or more applications indicated by the entry in the access control table at 808. For example, AppX may be provided access to a text-based message that includes the access control indicator “#AppX” where an entry in the access control table indicates that the application AppX is associated with the access control indicator “#AppX”. Providing access to the text-based message may include, in some instances, providing read permissions to the application for the text-based message data. In some cases, providing access to the text-based message may include providing the text-based message to an SMS listener of the indicated application.

In some cases, if it is not determined at 806 that the access control indicator is associated with an entry in the access control table, access to the text-based message may be provided to all applications on the user device that received the message at 810A (e.g., as shown in FIG. 5 and described above). In other cases, access to the text-based message may be provided to none of the applications on the user device at 810B (e.g., as shown in FIG. 6 and described above). In other cases, a server may be queried at 810C to determine whether it has an association with the access control indicator in its master access control table (e.g., as shown in FIG. 7 and described above). If the server has an association in its master access control table, the association is provided to the user device and its local access control table is updated at 812C. The text-based message may then be provided to the indicated application in the new entry of the access control table at 808.

It should be appreciated that the flowcharts and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as suited to the particular use contemplated.

1. A method, comprising:
receiving, at a device, a text-based message comprising an access control indicator in a body of the text-based message;
parsing the text-based message to locate the access control indicator;
determining whether the access control indicator is associated with a particular entry in an access control table, the access control table comprising associations between one or more access control indicators and one or more applications on the device;
determining that the text-based message is associated with a particular one of the applications on the device based on determining that the access control indicator is associated with the particular entry; and
allowing access to the text-based message by the particular application on the device based on determining, from the access control indicator, that the text-based message is associated with the particular application.

2. The method of claim 1, wherein a determination that the access control indicator is not associated with any entries in the access control table is to cause a query to be sent requesting applications associated with the access control indicator.

3. The method of claim 2, wherein a determination that the access control indicator is not associated with any entries in the access control table is further to cause the access control table to be updated based on an indication received in response to the query that a first application installed on the device is associated with the access control indicator.

4. The method of claim 1, further comprising allowing access to the text-based message by all applications installed on the device based on a determination that the access control indicator is not associated with an entry in the access control table.

5. The method of claim 1, further comprising deleting the text-based message without allowing access to the text-based message by any application on the device based on a determination that the access control indicator is not associated with an entry in the access control table.

6. The method of claim 1, wherein the text-based message is formatted as a Short Message Service (SMS) message.

7. The method of claim 6, wherein allowing access to the text-based message to the particular application on the device comprises providing the text-based message to an SMS listener for the particular application.

8. The method of claim 1, wherein the access control table further comprises associations between one or more senders and one or more applications, the method further comprises:
determining whether a sender of the text-based message is associated with the particular application in the access control table; and
providing the text-based message to the particular application based on determining that the sender is associated with the particular application in the access control table.

9. The method of claim 1, wherein each access control indicator in the access control table is associated with exactly one application on the device.

10. The method of claim 1, wherein the access control indicator includes a symbol followed by a set of alphanumeric characters.

11. The method of claim 10, wherein parsing the text-based message to locate the access control indicator comprises parsing the text-based message for the symbol.

12. The method of claim 1, further comprising:
installing a first application on the device;
transmitting a query to a server requesting access control indicators associated with the first application; and
updating the access control table based on an access control indicator received from the server.

13. A non-transitory computer readable medium having program instructions stored therein, wherein the program instructions are executable by a computer system to perform operations comprising:
accessing a text-based message;
parsing a body of the text-based message to locate an access control indicator;
performing a lookup in an access control table to determine whether the access control indicator is associated with one or more applications, the access control table comprising entries indicating associations between respective access control indicators and applications;
determining that the text-based message is to be provided to a particular application based on the access control table lookup;
allowing access to the text-based message by the particular application.

14. The non-transitory computer readable medium of claim 13, wherein the operations further comprise:
providing for transmission to a server a query requesting applications associated with the access control indicator based on a determination that the access control indicator is not associated with any entries in the access control table; and
updating the access control table based on information received from the server in response to the query.

15. The non-transitory computer readable medium of claim 13, wherein the access control table further comprises entries indicating associations between respective senders and applications, and the operations further comprise:
determining whether a sender of the text-based message is associated with the particular application in the access control table; and
allowing access to the text-based message by the particular application based on determining that the sender is associated with the particular application in the access control table.

16. The non-transitory computer readable medium of claim 13, wherein the operations further comprise:
installing a first application on the device;
providing for transmission to a server a query requesting access control indicators associated with the first application; and
updating the access control table based on an access control indicator received from the server.

17. A system comprising:
a data processing apparatus;
a memory; and
an access control engine, executable by the data processing apparatus to:
access a text-based message;
parse a body of the text-based message to locate an access control indicator;
determine whether the access control indicator is associated with a particular entry in an access control table, the access control table comprising associations between one or more access control indicators and one or more applications;
determine that the text-based message is to be associated with a particular one of the applications based on determining that the access control indicator is associated with the particular entry; and
allow access to the text-based message by the particular application based on determining, from the access control indicator, that the text-based message is associated with the particular application.

18. The system of claim 17, wherein the access control engine is further executable by the data processing apparatus to:
provide for transmission to a server a query requesting applications associated with the access control indicator based on a determination that the access control indicator is not associated with any entries in the access control table; and
update the access control table based on information received in response to the query.

19. The system of claim 17, wherein the access control table further comprises associations between senders and applications, and the access control engine is further executable by the data processing apparatus to:
determine whether a sender of the text-based message is associated with the particular application in the access control table; and
allow access to the text-based message by the particular application based on determining that the sender is associated with the particular application in the access control table.

20. The system of claim 17, wherein the access control engine is further executable by the data processing apparatus to:
install a first application on the device;
provide for transmission to a server a query requesting access control indicators associated with the first application; and
update the access control table based on an access control indicator received from the server.
